(19) United States
(12) Patent Application Publication
(10) Pub. No.: US 2016/0379046 A1
(43) Pub. Date: Dec. 29, 2016

(54) COMPUTERIZED SYSTEM AND METHODS FOR BIOMETRIC-BASED TIMEKEEPING

(71) Applicant: RESOLUTION INFORMATION, LLC, Beverly Hills, CA (US)

(72) Inventors: Robert W. Crandall, Santa Monica, CA (US); Artem Suvorov, Los Angeles, CA (US); Avi Kabani, Los Angeles, CA (US); Stephen P. Rucker, Plantation, FL (US)

(21) Appl. No.: 15/192,147

(22) Filed: Jun. 24, 2016

Related U.S. Application Data
(60) Provisional application No. 62/185,336, filed on Jun. 26, 2015.

(51) Int. Cl. G06K 9/00; G06Q 10/10; G07C 9/00

(52) U.S. Cl. CPC G06K 9/00288; G07C 9/00158; G06Q 10/1091

(57) ABSTRACT

A computerized system for biometric-based tracking of individuals. The system includes at least one processor configured to execute the instructions of one or more software modules stored on a nonvolatile computer readable medium, a media storage database, a time entry database configured to store at least one time entry, and an image processing module configured to transmit a digital image to a facial recognition service, to receive a response from the facial recognition service indicating an identity of a recognized person in the digital image, to store the digital image to the media storage database, and to store a time entry to the time entry database. The time entry includes the identity and the time at which the digital image was taken.

### CROSS REFERENCE TO RELATED APPLICATIONS

This application claims the benefit of U.S. Provisional Application No. 62/185,336, filed Jun. 26, 2015, which is incorporated by reference herein in its entirety.

### FIELD OF THE INVENTION

The present invention relates generally to the computerized and automatic tracking of personnel timekeeping. In particular, the invention provides a computerized system and method to automate the process of tracking when an employee is present at a certain location.

### BACKGROUND OF THE INVENTION

The present invention allows users to proactively monitor any discrepancies between employee time punches and actual time worked. One exemplary use of a preferred embodiment of the present invention can be used to solve the problem presented in one category of wage and hour class actions called off-the-clock claims of which there are thousands of claims filed per year. In accordance with a preferred embodiment of the present invention, the system will integrate with timekeeping systems and provide statistical analysis according to customized algorithms.

In light of these and other challenges in the prior art, there exists a need for computerized systems and methods for biometric-based timekeeping, such that an employer can automatically create and review records of employee entry and exit.

### SUMMARY OF THE PREFERRED EMBODIMENTS

In accordance with a first aspect of the present invention, there is provided a computerized system for biometric-based tracking of individuals. The system includes at least one processor configured to execute the instructions of one or more software modules stored on a nonvolatile computer readable medium, a media storage database, a time entry database configured to store at least one time entry, and an image processing module configured to transmit a digital image to a facial recognition service. In a preferred embodiment, the image processing module is further configured to receive a response from the facial recognition service indicating an identity of a recognized person in the digital image, to store the digital image to the media storage database, and to store a time entry to the time entry database. Preferably, the time entry comprises the identity and the time at which the digital image was taken.

In a preferred embodiment, the system includes a dashboard module configured to retrieve the digital image from the media storage database, to retrieve the time entry from the time entry database, and to provide a digital dashboard for presenting the digital image and the time entry to a user. Preferably, the dashboard module is further configured to receive a user request indicating a filtering criteria and to retrieve and present at least one at least one time entry based on the filtering criteria. In a preferred embodiment, the dashboard module is further configured to retrieve timekeeper data from a timekeeping system based on the filtering criteria, to analyze the timekeeper data to determine discrepancies between the timekeeper data and at least one time entry, and to present the discrepancies between the timekeeper data and the at least one time entry.

In a preferred embodiment, the system includes a local software application configured to receive the digital image from a camera and transmit the digital image to the image processing module. In another preferred embodiment, the local software application is configured to receive the digital image from a camera and store the digital image and metadata about the digital image to a digital queue, and the image processing module is further configured to retrieve the digital image from the digital queue.

In accordance with another aspect of the present invention, there is provided a computerized system for biometric-based tracking of individuals. The computerized system includes at least one processor configured to execute the instructions of one or more software modules stored on a nonvolatile computer readable medium, a local software application configured to receive a digital image from a camera and store the digital image and metadata about the digital image to at least one digital queue, at least one image processing module configured to retrieve the digital image from the at least one digital queue, to transmit a digital image to a facial recognition service, to receive a response from the facial recognition service indicating an identity of a recognized person in the digital image, to store the digital image to a media storage database, and to store a time entry to a time entry database. The time entry comprises the identity and the time at which the digital image was taken. In a preferred embodiment, the system includes a dashboard module configured to retrieve the digital image from the media storage database, to retrieve the time entry from the time entry database, to provide a digital dashboard for presenting the digital image and the time entry to a user, to receive a user request indicating a filtering criteria, and to retrieve and present at least one digital image and at least one time entry based on the filtering criteria. In a preferred embodiment, there are at least two image processing modules and at least two digital queues.

In accordance with yet another aspect of the present invention, there is provided a computer-implemented method for biometric-based tracking of individuals. The computer-implemented method includes the steps of: transmitting a digital image to a facial recognition service; receiving a response from the facial recognition service indicating the identity of a recognized person in the digital image; storing the digital image to a media storage database; and storing a time entry to a time entry database. The time entry comprises the identity and the time at which the digital image was taken. In a preferred embodiment, the computer-implemented method further includes the steps of: retrieving the digital image from the media storage database; retrieving the time entry corresponding to the digital image from the time entry database; and providing a digital dashboard for presenting the digital image and the time entry to a user. Preferably, the computer-implemented method also includes the step of receiving a user request indicating a filtering criteria. At least one time entry is retrieved and presented based on the filtering criteria. In a preferred embodiment, the computer-implemented method further includes the steps of: retrieving timekeeper data from a timekeeping system based on the filtering criteria; analyzing the timekeeper data to determine discrepancies between the timekeeper data and at least one time entry; and presenting the discrepancies between the timekeeper data and the at least one time entry.

In a preferred embodiment, the computer-implemented method further includes the steps of: receiving, by a local software application, the digital image from a camera; and transmitting the digital image to the image processing module. In another preferred embodiment, the computer-implemented method further includes the steps of: receiving, by a local software application, the digital image from a camera; storing the digital image to a digital queue; and retrieving the digital image from the digital queue.

One exemplary use of a preferred embodiment of the present invention can be used to solve the problem presented in one category of wage and hour class actions called off-the-clock claims of which there are thousands of claims filed per year. A preferred embodiment of the present invention passively monitors employee entrances and exits and integrates that with timekeeping data. Preferably, a timekeeping system is integrated with a system having facial recognition capabilities. In a preferred embodiment of the present invention, when a person walks into view of a camera, the camera takes a picture and compares that picture against known faces. In a preferred embodiment, the system determines whether the subject of the picture is an employee or not. Preferably, if the subject is an employee, the system creates a time record of when that employee entered and left the building. Preferably, if the subject is not an employee, the system will keep a record of the subject's entrance and de-identified data about that person such as age, race, The invention, together with additional features and advantages thereof, may be best understood by reference to the following description.

### BRIEF DESCRIPTION OF THE DRAWINGS

FIG. 1 is a diagram that conceptually depicts the architecture of a computerized biometric-based timekeeping system in accordance with a preferred embodiment of the present invention;

FIG. 2 is a diagram providing an overview of the components of a computerized biometric-based timekeeping system and the flow of data therebetween;

FIG. 3 is a flowchart depicting the computerized functions performed by the local application shown in FIGS. 1 and 2;

FIG. 4 is a block diagram depicting the functionality performed by the dashboard module and the flow of data between the dashboard module and other components of the system;

FIG. 5 is a block diagram showing the functions performed by the image processing module, the dashboard module, and other components of the computerized system 10 in accordance with an embodiment of the present invention;

FIG. 6 is an exemplar screen shot showing an employee enrollment web page presented by the dashboard module;

FIG. 7 is an exemplar screen shot showing a discrepancy analysis web page presented by the dashboard module;

FIG. 8 is an exemplar screen shot showing a list of enrolled employees presented by the dashboard module;

FIG. 9 is an exemplar screen shot showing a list of camera locations presented by the dashboard module;

FIG. 10 is an exemplar screen shot showing a list of time entries for a given facility presented by the dashboard module;

FIG. 11 is an exemplar screen shot showing a list of time entries for a known employee presented by the dashboard module;

FIG. 12 is an exemplar screen shot showing a list of time entries for unknown persons presented by the dashboard module; and

FIGS. 13-1 through 13-7 are, collectively, an entity relationship diagram depicting the tables of a central database in accordance with an exemplary embodiment of the present invention.

Like numerals refer to like components throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

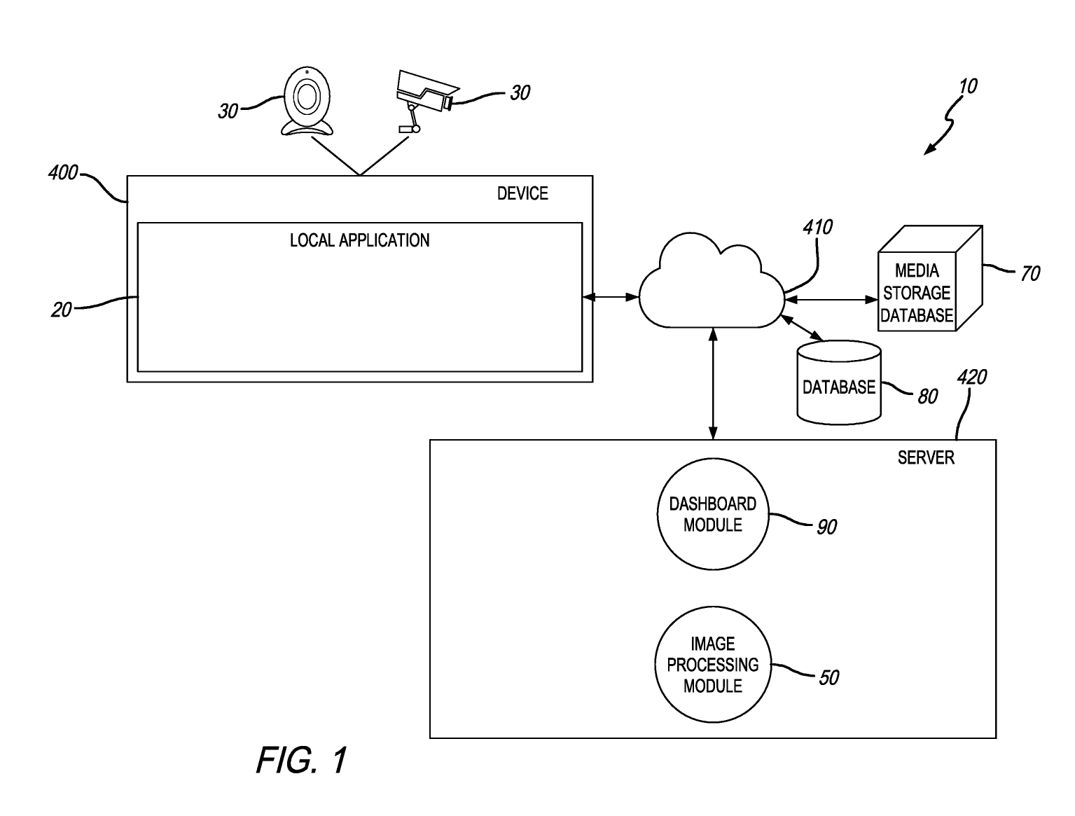

Referring now to the drawings, which are for purposes of illustrating the present invention and not for purposes of limiting the same, FIG. 1 is a diagram that conceptually illustrates the system architecture of a preferred embodiment of the present invention. In a preferred embodiment, there is provided a computerized biometric-based timekeeping system 10 having a computing device 400 in communication with at least one camera 30, and a server 420 in communication with the computing device 400 through network 410, and a media storage database 70 and a central database 80, each of which are in communication with the server 420 through the network 410. There is also provided a local application 20 configured to execute on computing device 400. Preferably, the computing device 400 is a computer having a central processing unit (CPU) and running the Windows operating system, and the local application 20 is a standalone software application that is compatible with the Windows operating system. However, it will be understood and appreciated by those of skill in the art that the computing device 400 could be replaced with, or augmented by, any number of computer device types or processing units, including but not limited to a desktop computer(s), laptop computer(s), mobile or tablet device(s), or the like, that computing device 400 can use the iOS, Windows Phone, Linux, Unix, OS X, or any other operating system, and that local application 20 is a standalone software application compatible with the operating system of computing device 400. It will also be understood by those of ordinary skill in the art that alternatively, local application 20 can be implemented within another application or within an operating system, or computing device 400 can be a dedicated hardware device wherein local application 20 is implemented within the firmware or hardware of the computing device 400. Those of ordinary skill in the art will also appreciate that the local application 20 can be provided via a computing device 400 that is a thin client, i.e., the local application 20 can run on one or more remote servers in connection with the computing device 400 such that the functionality of local application 20 is available on computing device 400. Those of ordinary skill in the art will also appreciate that the local application 20 can be provided on a distributed architecture. That is, local application 20 can be segmented such that portions of software application 400 can operate across additional servers or devices.

In a preferred embodiment, at least one camera 30 is a video camera that is connected by wire to the computing device 400 and provides a video stream to the computing device 400 such that the video stream is accessible to local application 20. However, those of ordinary skill in the art will appreciate that the camera 30 can be any device capable of transmitting or serving a digital image, such as a smartphone, an internet-connected webcam, or the like. The camera 30 can be in communication with the computing device 400 by any method capable of transmitting a digital image, such as via a wireless network, Bluetooth, local area network, or the Internet. Further, although FIG. 1 shows that there are two cameras 30 in communication with the local application 20 the number of cameras 30 that can be connected to the local application 20 is limited only by the amount of hardware resources of the computing device 400 or other resources available to support the local application 20. In a preferred embodiment, the media storage database 70 is an Amazon S3 hosted database, and the central database 80 is a relational database. However, those of ordinary skill in the art will appreciate that both the media storage database 70 and central database 80 can be any physical storage or storage structure, including a network DBMS, a flat file based DBMS, an object-oriented DBMS, a hierarchical DBMS, a flash drive, or any other data structure or system for storing data. Further, the data stored in central database 80 and media storage database 70 can be stored in a single physical storage, in separate physical storage(s), or across multiple physical storages.

In a preferred embodiment, the server 420 is a single hardware computing device having resources such as RAM (memory), a storage device, and a CPU. However, it will be understood by those of ordinary skill in the art that the server 420 can also be a virtual machine running on a single computing device or any combination of computing devices, including but not limited to the computing devices described herein, such as a desktop computer, laptop computer, mobile or tablet device, as well as storage devices that may be connected to network 410, such as hard drives, flash drives, removable media storage devices, or the like.

Preferably, there is provided a dashboard module 90 and an image processing module 50 that are software modules implemented on the server 420. However, it will be understood by those of ordinary skill in the art that the dashboard module 90 and the image processing module 50 can be implemented as software on separate servers or as hardware devices or firmware. Likewise, in a preferred embodiment, the media storage database 70 and the central database 80 are software database systems running on separate hardware devices. However, those of ordinary skill in the art will appreciate that the media storage database 70 and the central database 80 can be implemented as software database systems running on shared hardware, as tables or any other data structure within a single database system, as separate storage devices or firmware, or as any other data store, so long as both the media storage database 70 and the central database 80 are in communication with and available to both the dashboard module 90 and the image processing module 50.

Network 410 can consist of any network type, including but not limited to a local area network (LAN), wide area network (WAN), and/or the internet. The storage devices (e.g., hard disk 120, server 190, or other devices known to persons of ordinary skill in the art), are intended to be nonvolatile, computer readable storage media to provide storage of computer-executable instructions, data structures, program modules, and other data for the computing device of system 100, which are executed by CPU/processor 140 (or the corresponding processor of such other components). The various components of the present invention such as the media storage database 70, the central database 80, the dashboard module 90, and the image processing module 50, are stored or recorded on a storage device such as a hard disk, flash drive, flash memory, ROM, or the like, which may be accessed and utilized by the computing device 400 or the server 420.

Software and web or internet implementations of the present invention could be accomplished with standard programming techniques with rule based logic and other logic to accomplish the various steps of the present invention described herein. It should also be noted that the terms “component,” “module,” or “step,” as may be used herein and in the claims, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

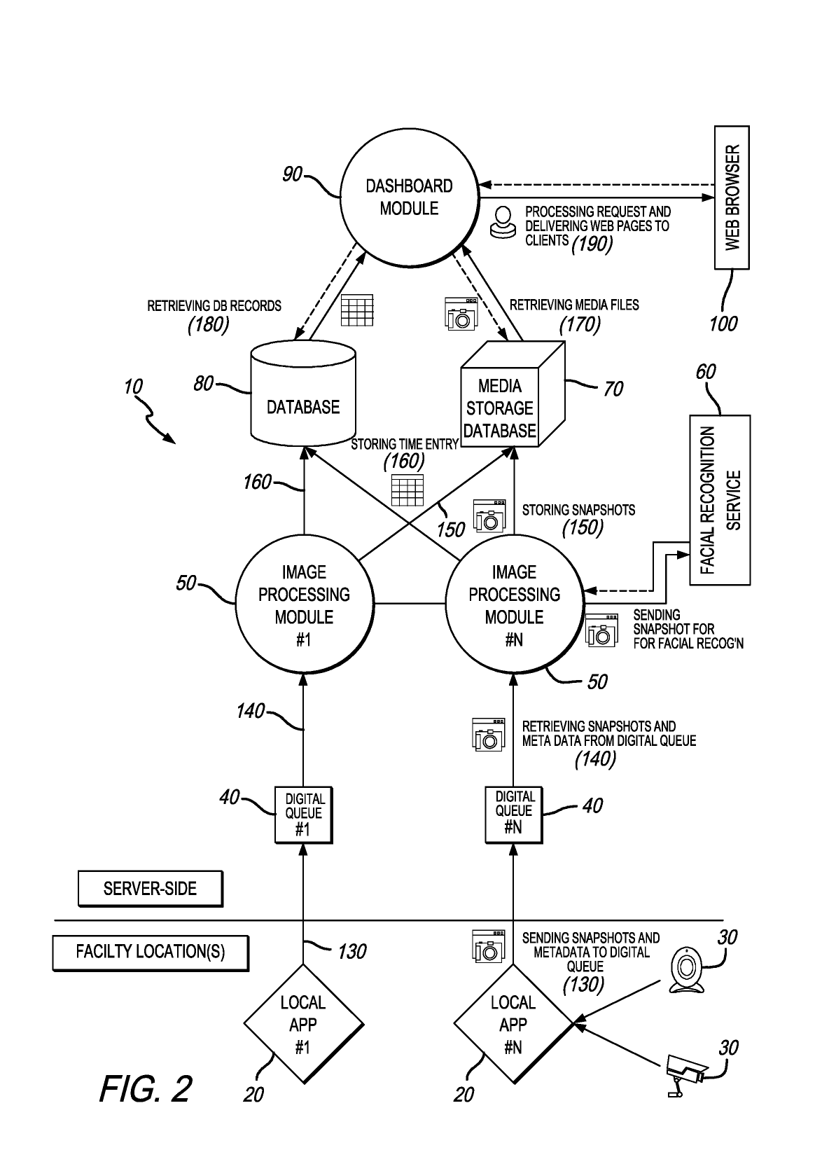

Referring now to FIG. 2, a diagram providing an overview of the components of a computerized biometric-based timekeeping system and the flow of data therebetween in accordance with a preferred embodiment of the present invention is shown. Preferably, as shown in FIG. 2, there are multiple instances of local application 20. However, those of ordinary skill in the art will understand that there can be one instance of local application 20, but that the biometric-based timekeeping system 10 of can be scaled as necessary to accommodate additional instances of local application 20. For example, additional data storage, databases, computing and storage hardware, network capacity, and/or additional instances of the image processing module 50 can be added to the system 10 to support additional instances of the local application 20.

In a preferred embodiment, the local application 20 receives a constant stream of video from the cameras 30. The local application 20 takes a frame from the video stream and saves it as a digital image (also referred to herein and in FIGS. 1 and 2 as a “snapshot”) along with metadata pertaining to the snapshot. Preferably, the local application 20 takes and saves a snapshot at a regular time interval and the local application 20 appends metadata to the snapshot such as the time and location at which the snapshot was taken from the stream. The regular time interval can be any desired interval. For example, the regular time interval can be between as small as a millisecond or as great as twenty four hours. The snapshots can also be taken at irregular time intervals. For example, the snapshots can be taken in a greater amount during peak hours. The local application 20 can also take and save a snapshot at any time interval or in response to any other detectable stimuli. For example, the local application 20 can take and save a snapshot from the video stream in response to a detected movement in the video frame or a detected sound, or triggered by a user of the local application 20. The local application 20 can also save snapshots that are uploaded from a smartphone acting as a camera 30, as the snapshots are uploaded. The local application 20 can also receive metadata pertaining to the snapshot from the camera 30 and append that metadata to the snapshot. Further, the local application 20 can also store or transmit the stream itself

In a preferred embodiment, as shown in FIG. 2, there are multiple instances of digital queues 40. However, as with the local application 20 discussed above, those of ordinary skill in the art will appreciate that there can be one digital queue 40 or that more instances of digital queue 40 can be added to scale the system. Preferably, the local application 20 then transmits the snapshot and metadata to the digital queue 40, 130. In a preferred embodiment, the instances of digital queues 40 are implemented as software residing on a server that is remotely accessed by the local applications 20 by network 410. However, it will be appreciated by those of ordinary skill in the art that the digital queues 40 can be implemented as part of the image processing modules 50, as part of the local applications 20, as software residing on the computing device(s) 400, as a separate hardware device, or as any software module or hardware component that is in communication with the local applications 20. Preferably, as shown in FIG. 2, there is one digital queue 40 for each instance of a local application 20. However, a one-to-one ratio of local applications 20 to digital queues 40 is merely exemplary, and there may be multiple digital queues 40 used by an instance of a local application 20, or fewer digital queues 40 than instances of local applications 20 such that several local applications 20 share the use of a digital queue 40. In another embodiment, an instance of the local application 20 can transmit or make accessible the snapshot to an image processing module 50 without the use of a digital queue 40.

In a preferred embodiment, as shown in FIG. 2, the image processing module 50 retrieves the snapshot from the digital queue 40, 140. The image processing module 50 then sends the snapshot to a facial recognition service 60. The facial recognition service analyzes the contents of the snapshot and then transmits a response to the image processing module 50 indicating an identity of a recognized individual in the snapshot. Preferably, the image processing module 50 then stores the snapshot to the media storage database 70, combines the identity with the metadata and an identifier (which identifies the corresponding snapshot) to create a time entry, and stores the time entry to the central database 80, 160. Those of ordinary skill in the art will appreciate that the identity, the identifier, the metadata, or any other component of the time entry need not be stored together as a single record, but rather can be stored in separate records or databases.

Preferably, as shown in FIG. 2, the dashboard module 90 serves web pages to a user's web browser 100, 190. The dashboard module 90 retrieves time entries from the central database 80, 180. The dashboard module 90 also retrieves snapshots from the media storage database 70, 170. The dashboard module 90 then presents the snapshots and the time entry data and presents them to the user via the web page 190. Further, a user can send requests to view specific time entry data and snapshots, including time entries and snapshots filtered by identity, time, location, or any other parameter stored in the central database 80, 190. The dashboard module processes the user's requests and accordingly presents the user with the data and snapshots requested 190. Those of ordinary skill in the art will appreciate that the presentation of a web-based interface accessed via web browser 100 by the dashboard module 90 to receive and process requests from users 190 is merely exemplary, and that the dashboard module 90 may also present data to and receive and process requests from users by communicating with a native software application running on a personal computer, tablet, smartphone, or other device, a dedicated hardware device, or any other device capable of receiving user input, and transmitting requests to and receiving data from the dashboard module 90.

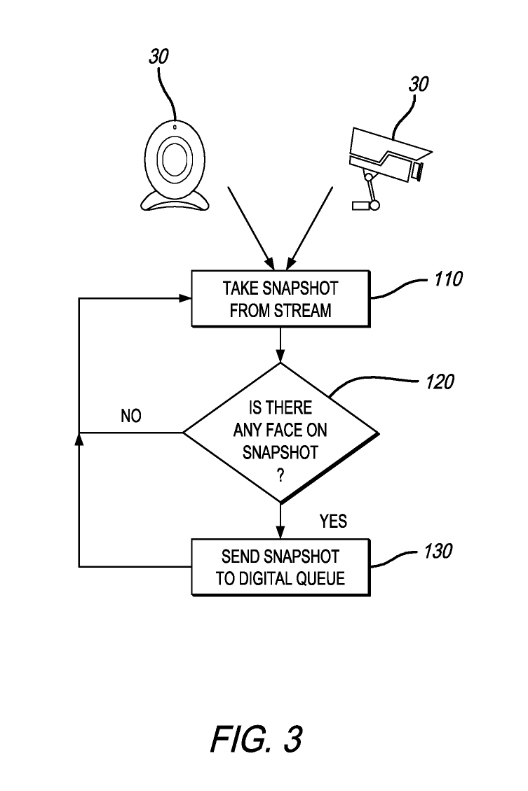

FIG. 3 is a flowchart depicting the computerized functions performed by the local application 20 in accordance with a preferred embodiment of the present invention. As shown in FIG. 3, and described above, the local application 20 takes a snapshot from the video stream 110. Preferably, the local application 20 then checks to see if there is a face in the snapshot 120, by using a face-detecting software library. However, this step can be performed by sending the snapshot to a third party face detection service or any other computer implemented function that detects faces in an image. In a preferred embodiment, if there is a face detected in the snapshot, the local application 20 stores the snapshot to the digital queue 40, 130. If there is no face detected in the snapshot, the local application 20 then proceeds to take another snapshot from the stream.

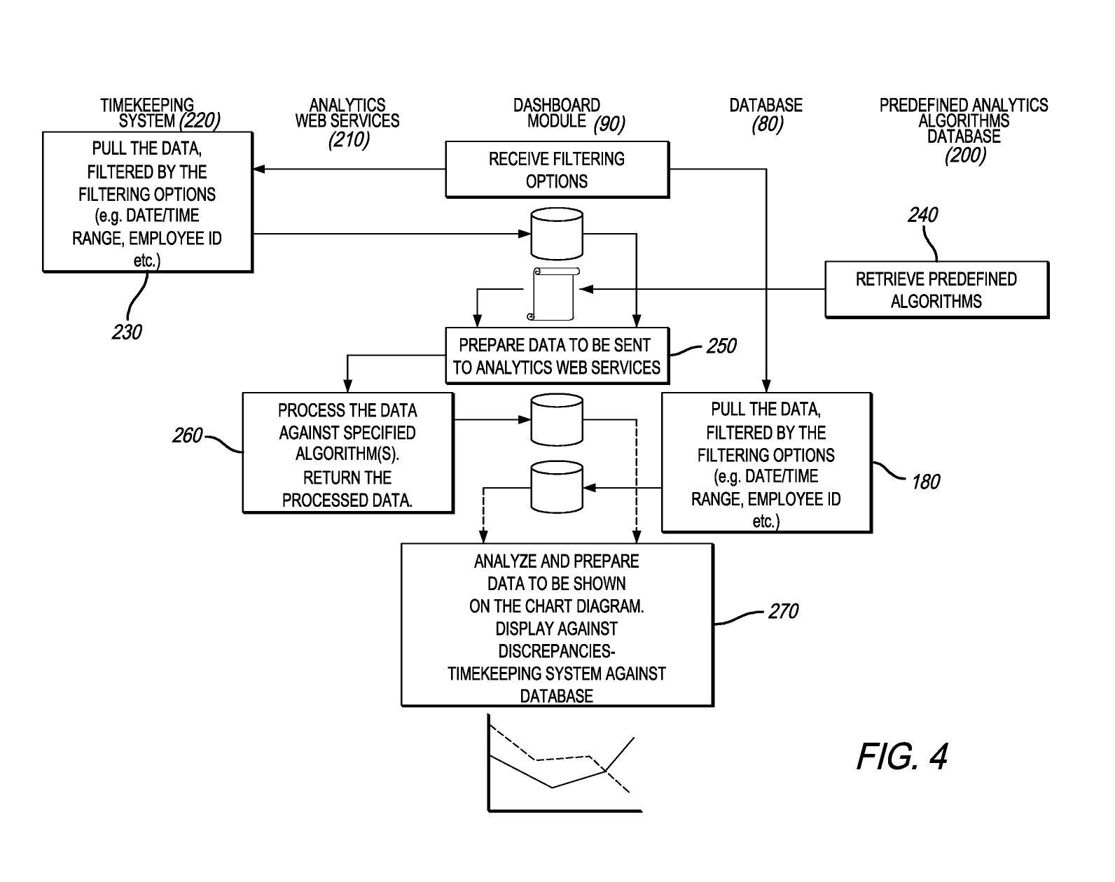

Referring now to FIG. 4, a block diagram depicting the functionality performed by the dashboard module 90 and the flow of data between the dashboard module 90 and other components of the system 10 in accordance with a preferred embodiment of the present invention is shown. The dashboard module 90 receives filtering options, such as a date and/or time range, employee ID number, etc., from a user, as described above. The dashboard module 90 then retrieves specific timekeeping data relating to the filtering options from a timekeeping system 220. The timekeeping system 220 is a traditional timekeeping system that employees use to clock in and out of a facility. In a preferred embodiment, there is provided a predefined analytics algorithms database in which analytics algorithms for analyzing data sent to analytics web services 210 are stored. Preferably, analytics web services 210 is an SAS analytics web service. However, it will be appreciated by those of ordinary skill in the art that the use of the SAS analytics web service is merely exemplary and that any analytics system or service can be used. Preferably, the dashboard module 90 retrieves predefined analytics algorithms from the predefined analytics algorithms database 200, 240 and then prepares the data to be sent to the analytics web services 210, 250. This step involves formatting the timekeeping data so that it is compatible with analytics web services 210. Preferably, the dashboard module 90 then transmits the formatted timekeeping data, along with the predefined algorithms retrieved from the predefined analytics algorithms database 200, to the analytics web services 210, where the timekeeping data is processed in accordance with the predefined algorithms, and then returned to the dashboard module 90, 260. The dashboard module also retrieves the time entries from the central database 80, 180. Then, the dashboard module 90 prepares the processed timekeeping data and the time entries for display to the user. In a preferred embodiment, the timekeeping data and the time entries are both prepared to be presented in a chart 270. The dashboard module 90 also displays any discrepancies between the timekeeping data retrieved from the timekeeping system 220 and the time entries retrieved from the central database 80, 270. Thus, preferably, the computerized biometric-based timekeeping system 10 can be used to determine whether a snapshot shows the individual entering a facility location at the time that he supposedly clocked in to timekeeping system 220. In a preferred embodiment, the dashboard module 90 can prepare and present data in chart or visual form. Preferably, the dashboard module 90 provides notifications of discrepancies between entries in a timekeeping system 220 and those stored by the image processing tool 50.

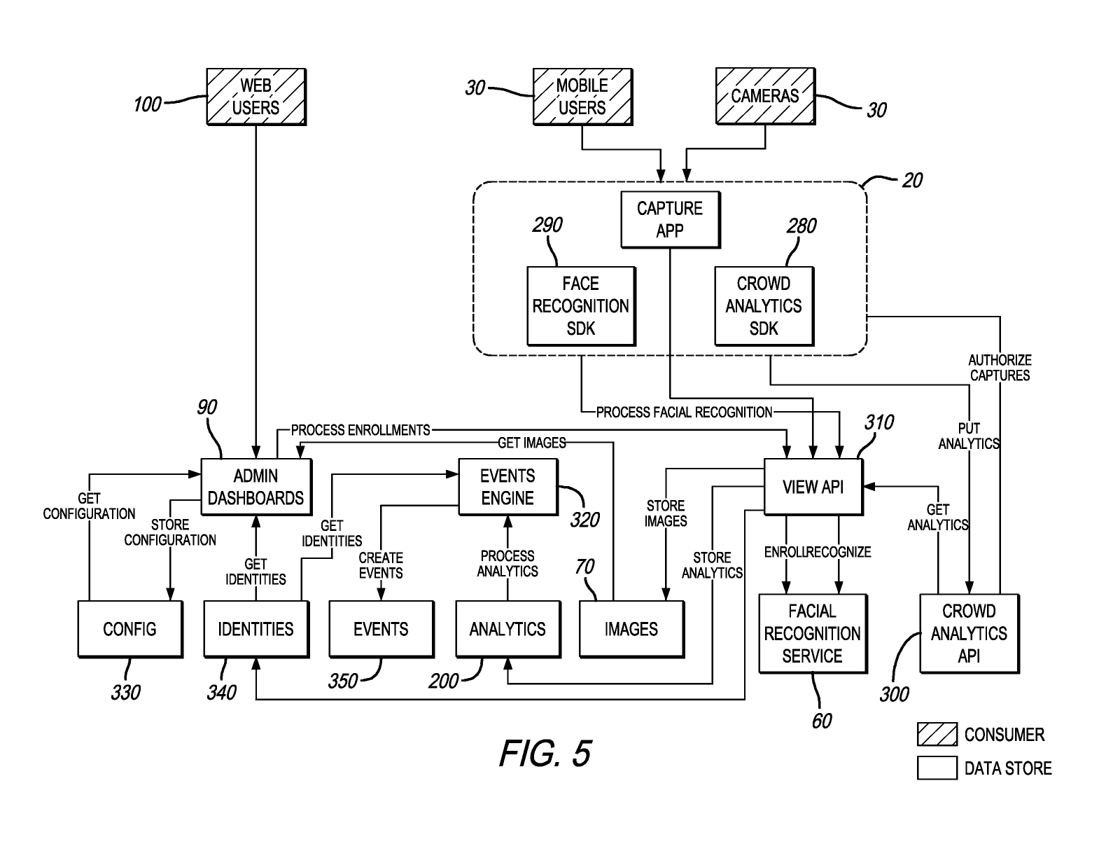

Referring now to FIG. 5, a block diagram depicting functions performed by the image processing module 50, dashboard module 90, and other parts of the system 10 in accordance with another exemplary embodiment of the present invention is shown. As discussed above and shown in FIGS. 1-3, there are provided cameras 30 including mobile users. Preferably, the dashboard 90 is in communication with users 100 through web pages as described above. Local application 20 includes a capture application which is a software module or hardware device that takes the snapshot from the stream from the cameras 30 as described in step 110 of the description of FIG. 3 above. Preferably, local application 20 also has a face recognition SDK (software development kit) or library, which detects whether there is a face in a snapshot, as described in step 120 of the description of FIG. 3 above. In a preferred embodiment, the local application 20 has a crowd analytics SDK 280 which sends the snapshot along with analytics algorithms to a crowd analytics API (application programming interface) 300, which is a service which then analyzes the faces of a crowd of individuals in the snapshot and provides demographic data about the subject of a snapshot. Preferably, the crowd analytics API 300 will provide data about the subject to the view API 310 such as age, race, gender, or other demographic category to the view API 310. For example, the crowd analytics API can analyze a snapshot in accordance with the provided analytics algorithms and determine the average age, emotional state, ethnicity, etc. of the crowd of individuals. Preferably, the local application 20 and the crowd analytics API 300 both transmit their respective outputs to a view API 310, which is a software module or service that processing requests to store data for the system 10 to use. For example, in a preferred embodiment, the view API 310 stores the analytics received from the crowd analytics API 300, data regarding the number of calls by the view API 310 to the facial recognition service 60, and the analytics algorithms to the analytics database 200. Preferably, the view API 310 also can receive a request from the dashboard module 90 to process enrollments of new users. In a preferred embodiment, the view API 310 also includes the image processing module 50. Thus, preferably, the view API 310 transmits the snapshots along with certain data to the facial recognition service 60 to enroll a new individual or to identify a recognized individual. The view API 310 also stores the snapshots to the media storage database 70. The view API 310 also stores time entries, including the identities of recognized persons, to the identities database 340. In a preferred embodiment, there is provided an events engine 320 which then retrieves time entries and identities from the identities database 340 and processes them according to the data in the analytics database 360 to create and store events in the events database 350. Finally, the dashboard module 90 also can store and retrieve settings and configurations from the configuration database 330.

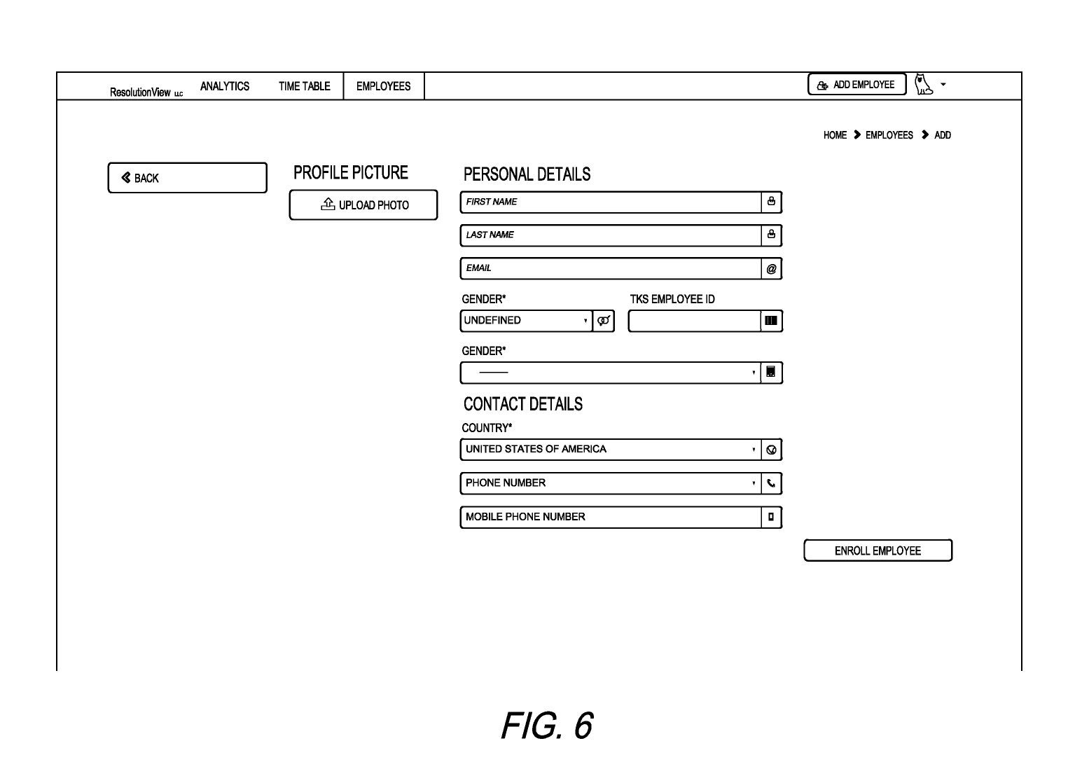

FIG. 6 is an exemplar screen shot showing an employee enrollment web page presented by the dashboard module 90 in accordance with a preferred embodiment. As shown in FIG. 6, there is provided an option to upload a photograph of an individual being enrolled as well as contact information and personal details. When the user uploads a photograph and enrolls the individual, the dashboard module 90 will send the photograph to the view API 310 which then sends the photograph to the facial recognition service 60 for enrollment so that individual can be recognized in later-taken snapshots.

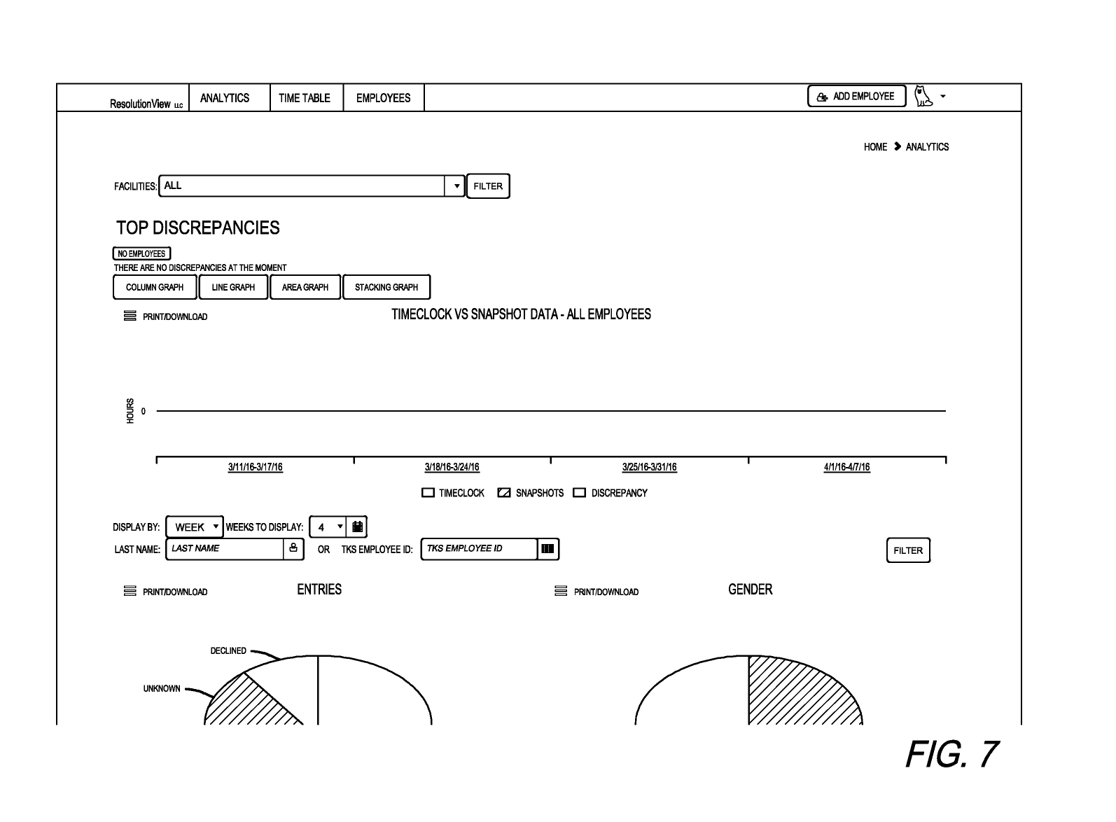

FIG. 7 is an exemplar screen shot showing a discrepancy analysis web page presented by the dashboard module 90 in accordance with a preferred embodiment, such as, for example, in step 270 shown in FIG. 4. As shown in FIG. 7 the user can filter by facility, last name, employee ID, and date range. The dashboard module 90 also provides charts regarding discrepancies between the data in the timekeeping system 220 and the time entries stored in the central database 80, sorted by gender, etc.

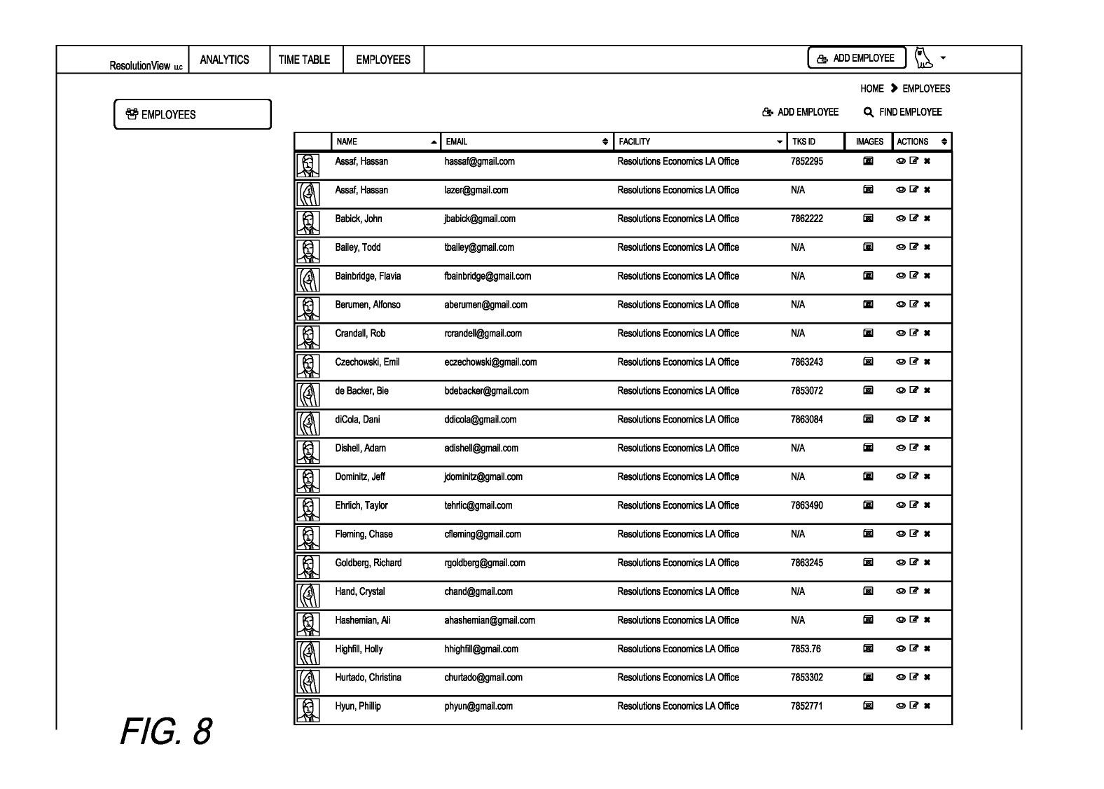

FIG. 8 is an exemplar screen shot showing a list of enrolled employees presented by the dashboard module 90 in accordance with a preferred embodiment. As shown in FIG. 8, the dashboard module 90 presents a web page by which the user can see the name, facility, and timekeeper ID of an enrolled individual, and also provides links to snapshots of the enrolled individuals.

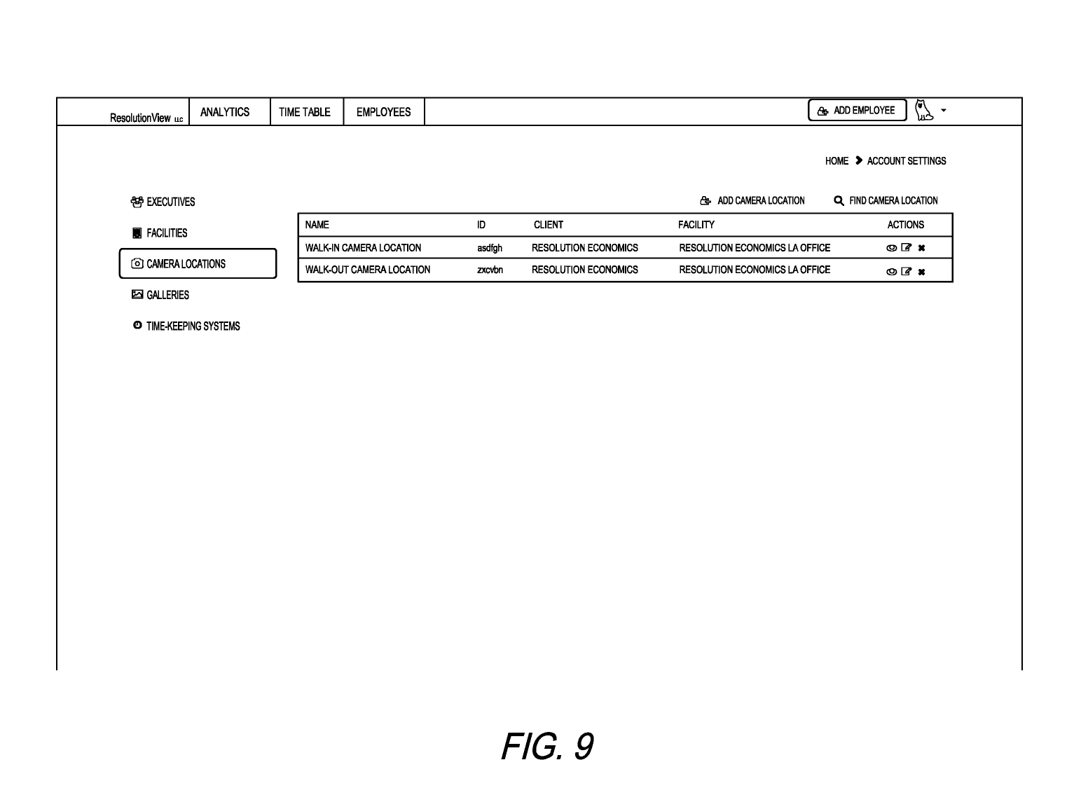

FIG. 9 is an exemplar screen shot showing a list of camera locations presented by the dashboard module 90 in accordance with a preferred embodiment. As shown in FIG. 9, the dashboard module 90 can show the location and facility for cameras 30 at a certain facility.

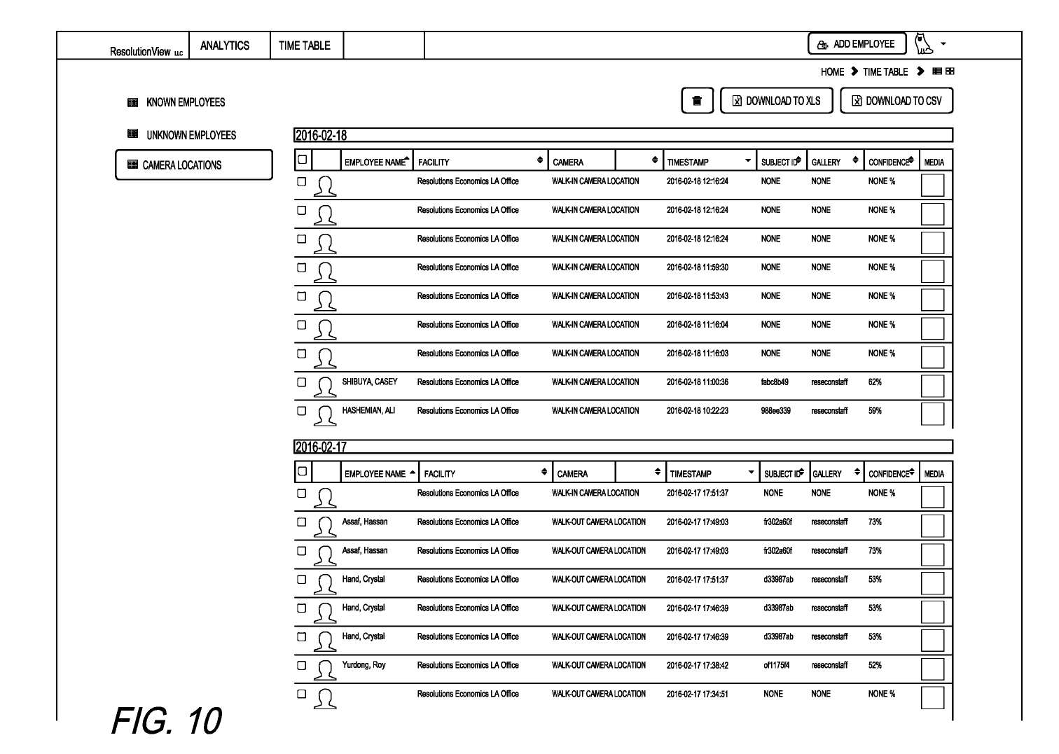

FIG. 10 is an exemplar screen shot showing a list of time entries for a given facility presented by the dashboard module 90 in accordance with a preferred embodiment. As shown in FIG. 10, the dashboard module 90 provides a list of time entries for a facility, including the name of the employee (if recognized), the name of the facility, the camera location, the timestamp of the snapshot, a subject ID (a unique identifier for the recognized person), a gallery (a personnel group that the subject belongs to, if any), and a confidence value that reflects the degree of confidence in which the system 10 believes the displayed time entry is accurate.

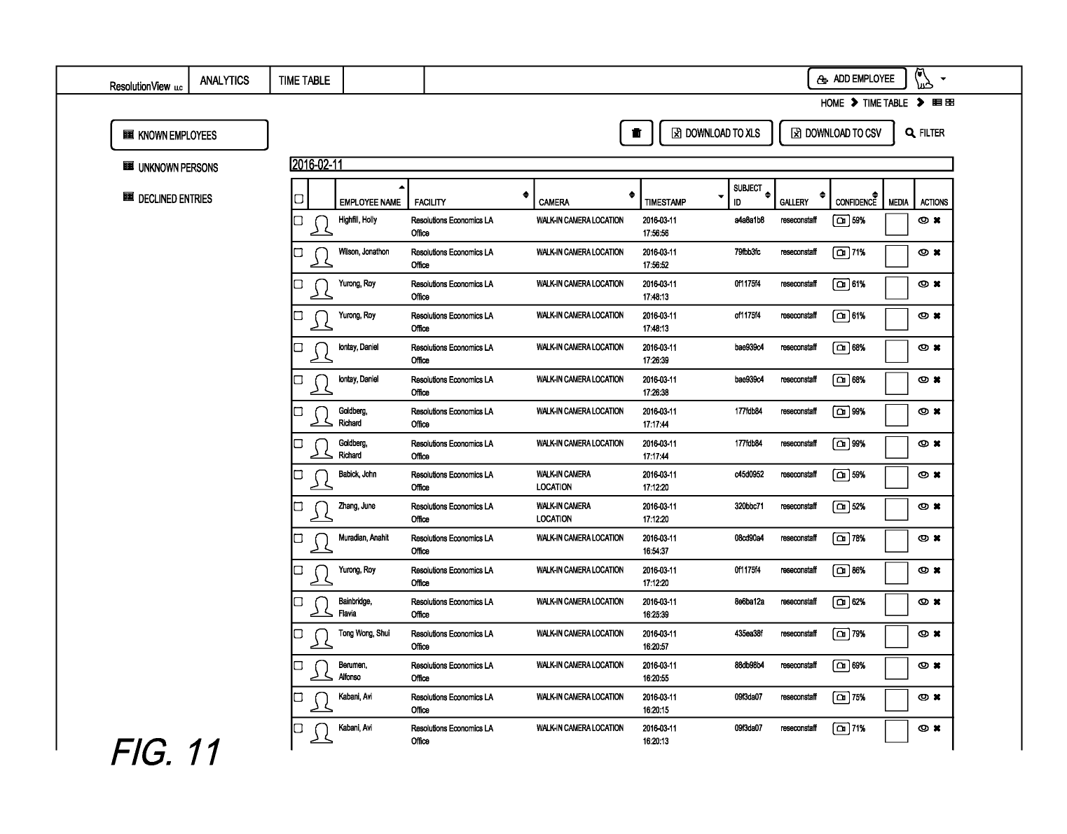

FIG. 11 is an exemplar screen shot showing a list of time entries for a known employee presented by the dashboard module 90 in accordance with a preferred embodiment. As shown in FIG. 11, the data presented is the same as that in FIG. 10; however, it is limited only to employees that are enrolled within the system 10.

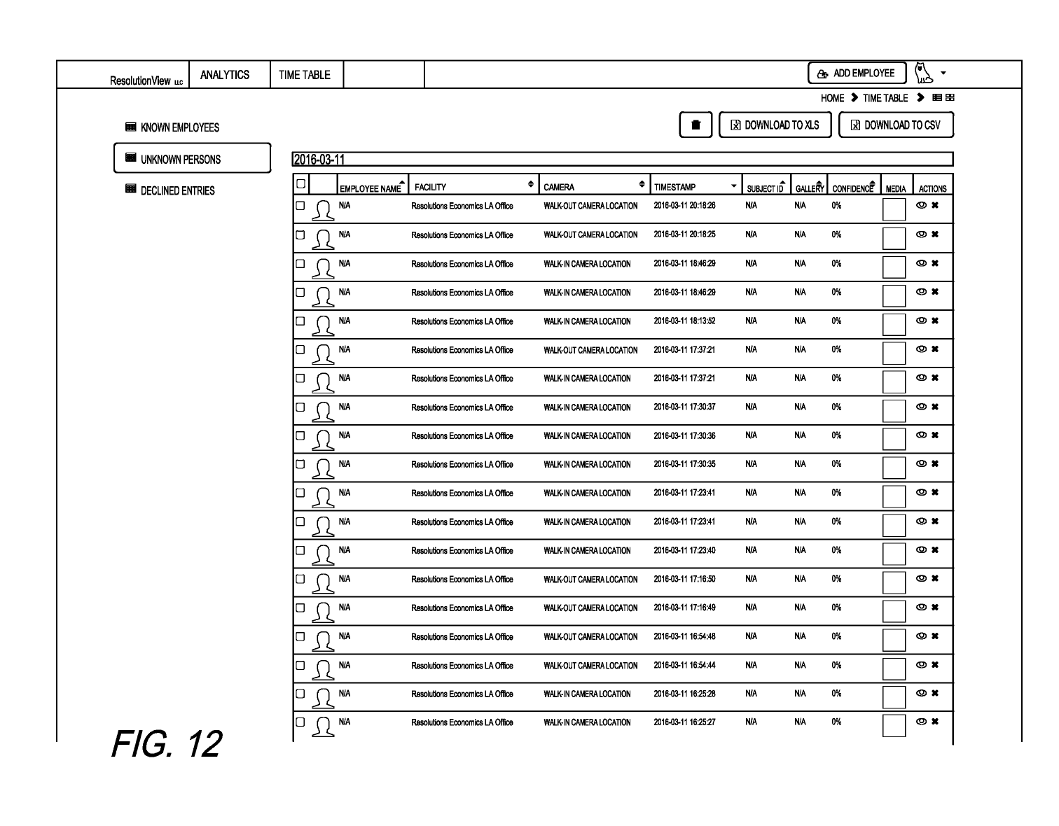

FIG. 12 is an exemplar screen shot showing a list of time entries for unknown persons presented by the dashboard module 90 in accordance with a preferred embodiment. As shown in FIG. 11, the data presented is the same as that in FIGS. 10 and 11; however, it is limited only to employees that are not recognized by the system 10.

FIGS. 13-1 through 13-7 are, collectively, an entity relationship diagram depicting the tables of the central database 80 in accordance with an embodiment of the present invention. As stated above, FIGS. 13-1 through 13-7 merely depict a preferred embodiment in which the central database 80 is a relational DBMS (database management system) and the pictured tables are relational tables. However, those of ordinary skill in the art will appreciate that the central database 80 can be a network DBMS, a flat file based DBMS, an object-oriented DBMS, a hierarchical DBMS, or any other data structure or system for storing data. Further, as stated above, the data stored in central database 80 can be stored in a single physical storage, in separate physical storage(s), or across multiple physical storages. Further still, those of ordinary skill in the art will appreciate that the particular organization of data into the tables depicted in FIGS. 13-1 through 13-7 is merely exemplary and specific to an exemplary implementation, and that FIGS. 13-1 through 13-7 is are not a limitation on the present invention and the system 10 may use any organization of data in central database 80.

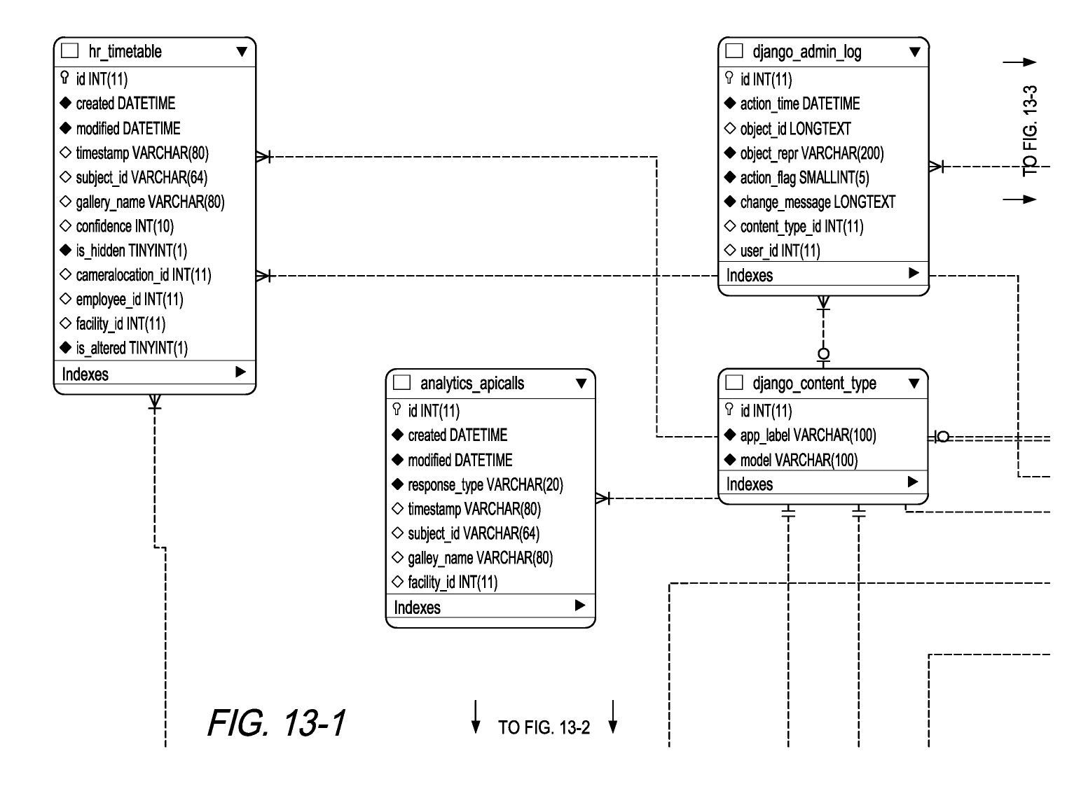

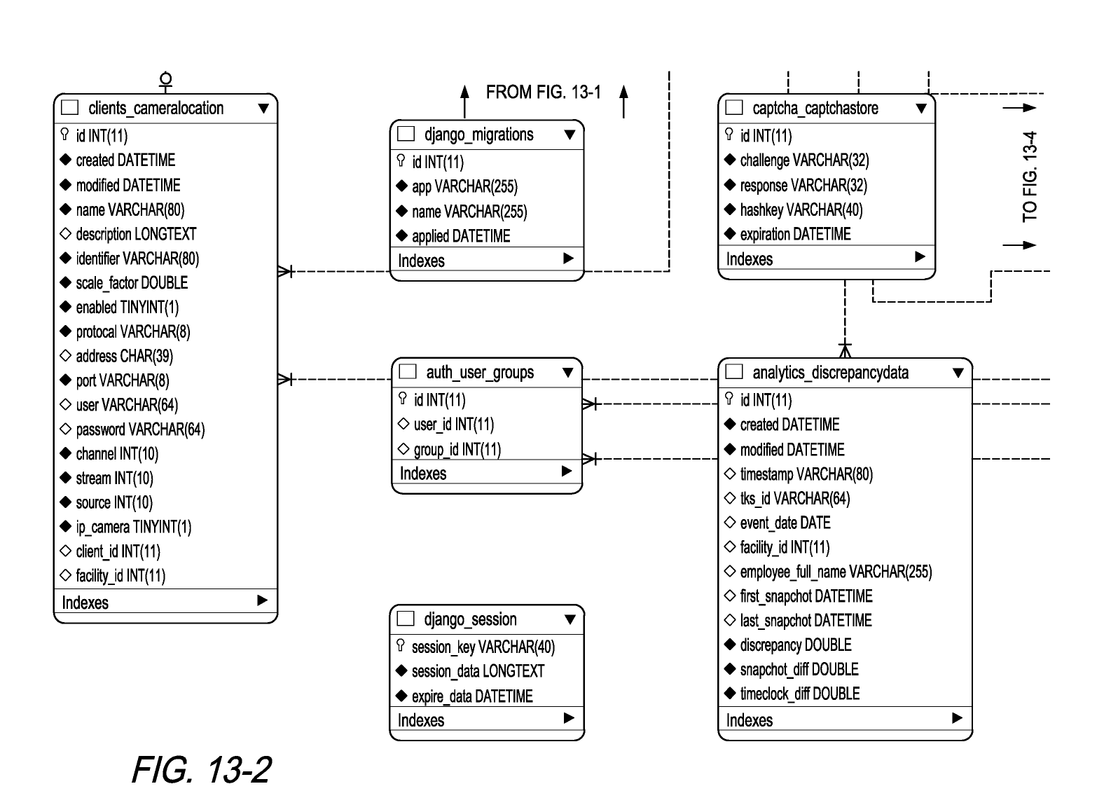

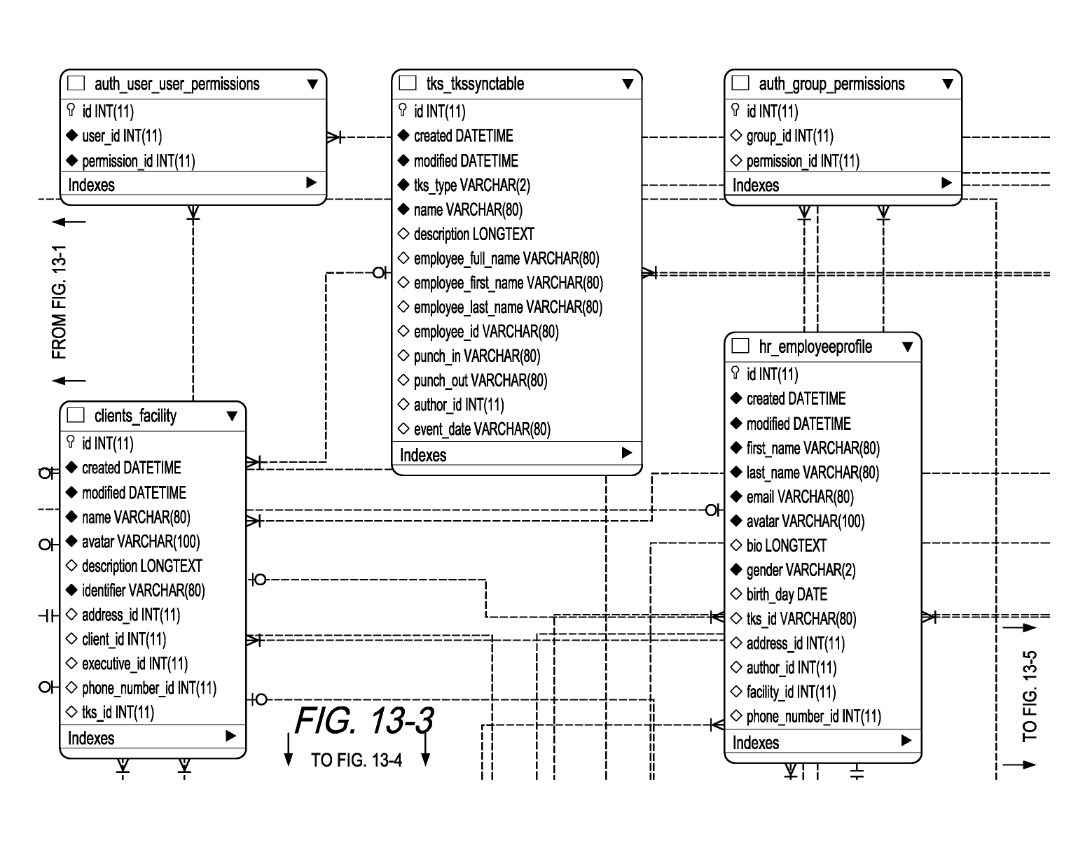

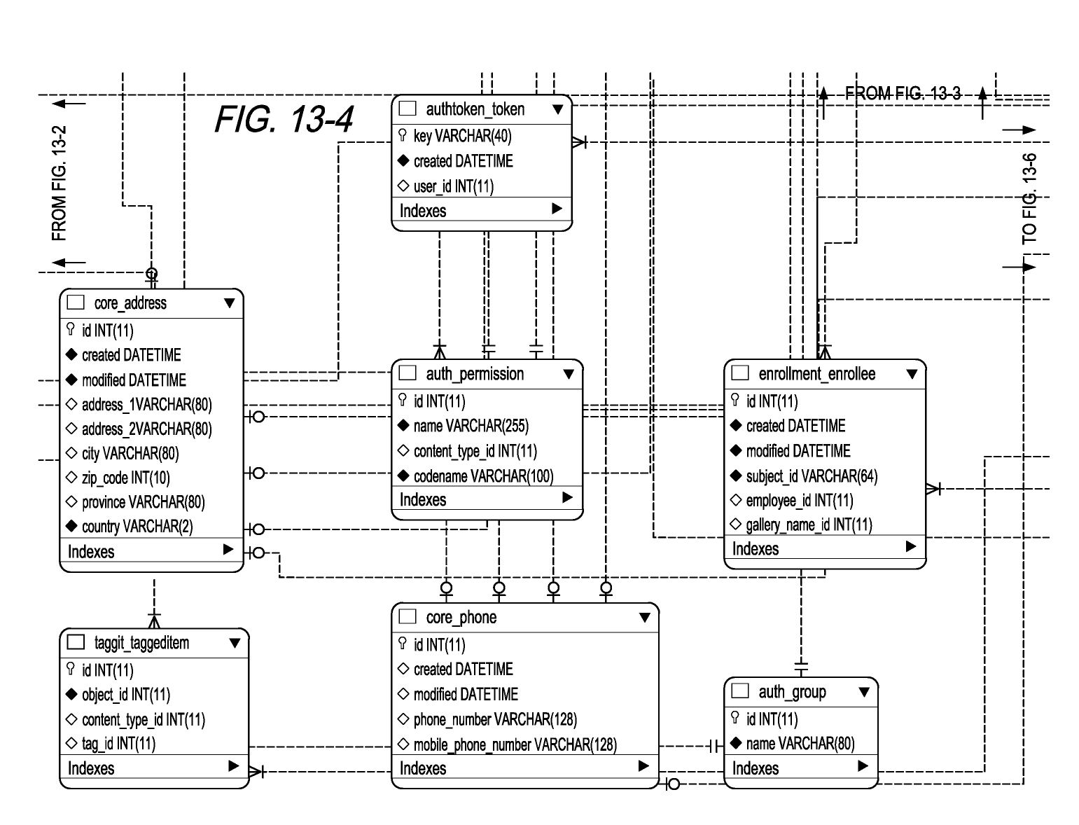

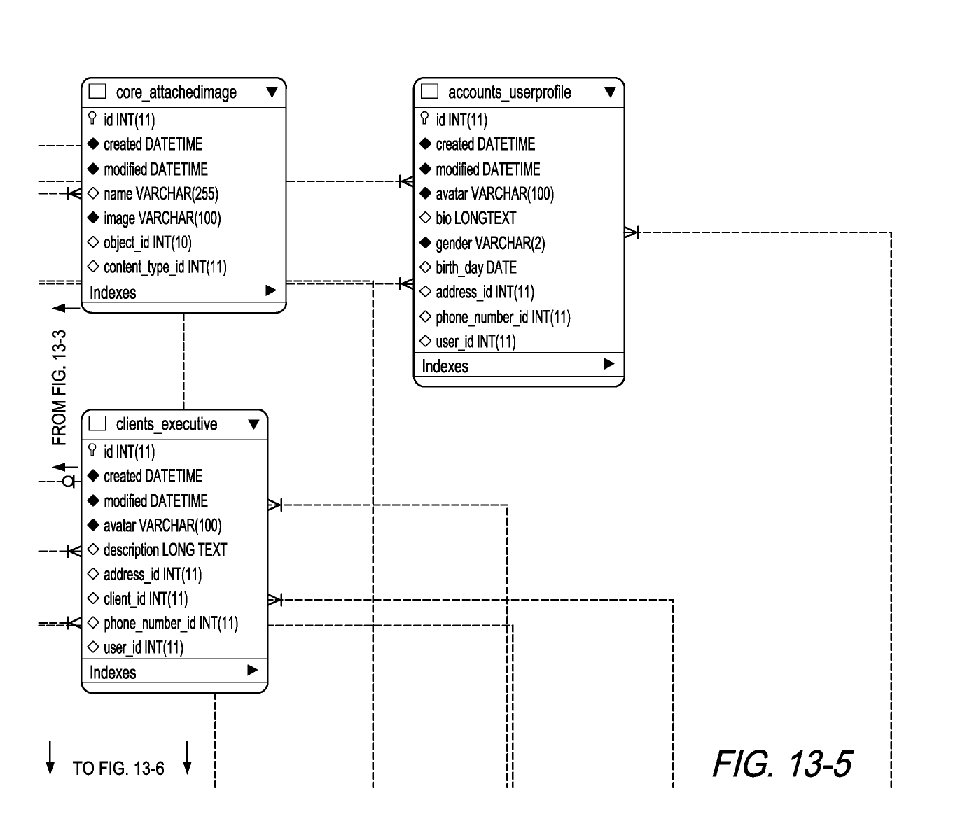

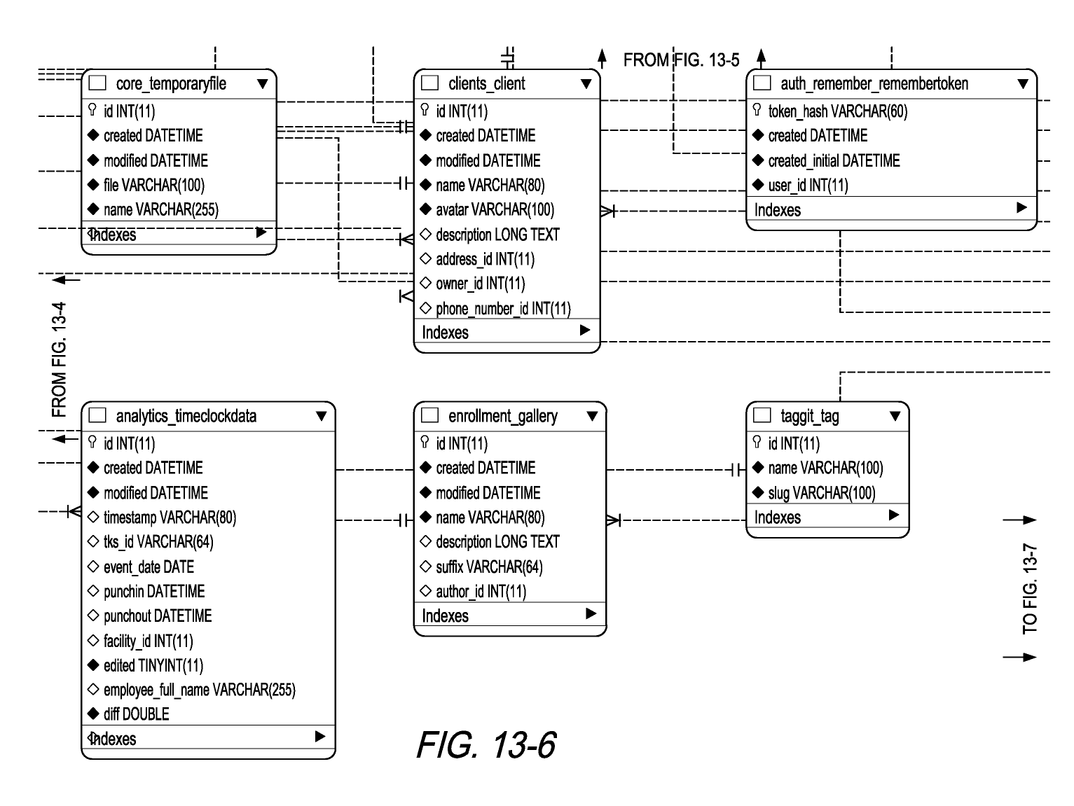

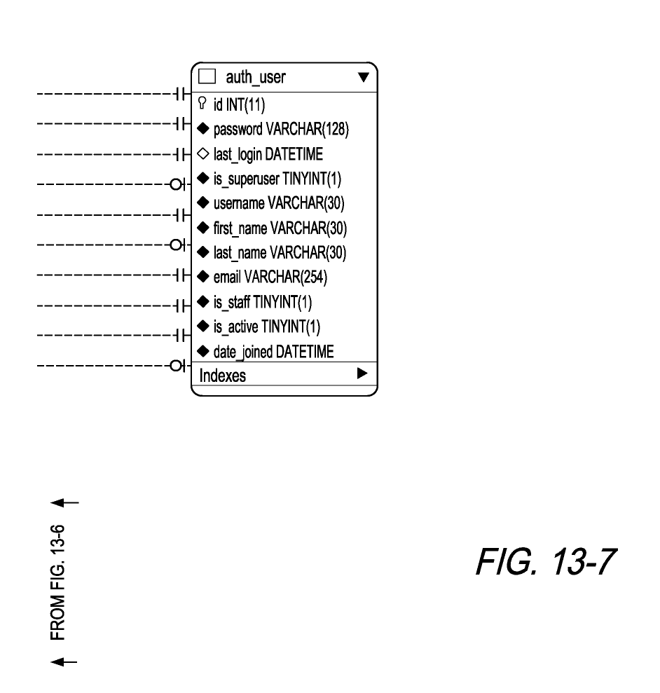

Preferably, as shown in FIGS. 13-1 and 13-2, there are django_admin_log, django_content_type, django_migrations, auth_user_groups, auth_user_user_permissions, auth_group_permissions, and django_session tables, which are used to support and manage the Django framework used by the dashboard module 90 to serve web pages. However, it will be appreciated by those of ordinary skill in the art that the use of the Django framework or a web server at all (as stated above), is merely exemplary and that the dashboard module 90 can provide a dashboard via any web framework or server, or via a native application for a PC or a smartphone. As shown in FIG. 13-1, there is preferably an hr timetable, which is a central database 80 and stores timestamps, subject_ids for recognized persons, galleries, camera locations, confidence levels, employee IDs, facility IDs, and a field that allows one to alter timetable entries manually. Preferably, there is also an analytics_apicalls table that is used to track the number of API calls from the view API 310 to the facial recognition service 60. As shown in FIG. 13-2, in a preferred embodiment, there is a clients_cameralocation table that stores the location of the cameras 30, an identifier for the camera 30, and technical information related to each camera 30, such as the IP address of the camera, the web port, the username and password for the camera 30, the channel, stream, protocol, and source of an IP camera 30, the client ID, and the facility ID. Preferably, there is also an analytics_discrepancydata that stores the discrepancies between timeclock data taken from the timekeeping system and snapshots. Preferably, there is also provided a captch_captchastore table that stores data from a third party application relating to the use of captchas to validate that the user is a person and not a bot.

As shown in FIG. 13-3, in a preferred embodiment, there is provides a tks_tkssynctable, which is used to tell the dashboard how to interact with the user's timekeeping system. For example, those of ordinary skill in the art will understand that the timekeeping system (TKS) 220 (as shown in FIG. 4 and described above), can be any timekeeping system, including timekeeping systems by third parties, including but not limited to Kairos or BigTime. Thus, the timekeeping system 220 may have its own database layout and column names. The tks_tkssynctable may then include fields including tks type, which indicates the type of timekeeping system. Preferably, there is also provided a clients_facility table, which stores records representing a client's facility and related data, including the name, avatar, description, identifier, and address ID for a client facility. In a preferred embodiment, there is provide an hr_employeeprofile table, which stores records representing an employee profile, including first and last names, contact information, birthdates, gender, bio, the employee's ID in the client's timekeeping system 220, the address ID (which stores the ID of a stored address), the author ID (i.e., the foreign key to a record of the user who created the profile, Facility ID (i.e., a foreign key to a stored facility record), and a phone number ID (i.e., a foreign key to a stored phone number).

As shown in FIG. 13-4, in a preferred embodiment, there is provided a core_address table, which stores addresses. Preferably, there is a core_phone table that stores phone numbers. In a preferred embodiment, there is an enrollment enrollee table that stores enrollee information and is used by the facial recognition service 60, the image processing module 50, and the dashboard module 90 to identify enrolled individuals, and stores records that include a subject ID (a unique ID in the facial recognition service 60), an employee ID (a foreign key to the hr_employeeprofile table), and the gallery name.

As shown in FIG. 13-5, in a preferred embodiment, there is provided a core_attachedimage table, which stores records representing the stored snapshots. Preferably, the core_attachedimage table has fields for the image name (the filename of the stored snapshot) and the image (which is the path at which of the snapshot file can be accessed). In a preferred embodiment, there is also provided an accounts userprofile table, which stores records representing the registered user profiles for users of the dashboard module 90, such as clients and executives of the clients. Preferably, the accounts_userprofile table has fields for an avatar, bio, gender, birthdate, the address ID for the user, the phone number ID for the user, a user ID (a foreign key to the user_id fields of other tables).

As shown in FIG. 13-6, in a preferred embodiment, there is provided a core_temporaryfile table for storing temporary files. Preferably, there is provided a clients_client table, which stores records representing a client profile, having fields including name, avatar, description, address ID, and owner ID (a foreign key to a user instance), and phone number ID. In a preferred embodiment, there is also provided an analytics_timeclockdata table which stores information related to the analytics timeclock data, including punch-in and punch-out times, TKS ID, facility ID, the full name of employees, and the times at which the record have been modified and created. Preferably, there is also an enrollment_gallery table, which stores records representing the gallery in which employees are enrolled, having fields for the suffix (which randomly generates a unique hash value that is appended to gallery names to differentiate them for security purposes in the case where two clients enter identical gallery names) and author ID.

In a preferred embodiment of the present invention, an Analytics Engine is provided, that performs an algorithm that compares the timestamp of a snapshot to data stored in a timekeeping system. If the discrepancy between an entry in a timekeeping system and the timestamp of a snapshot is greater than a predetermined discrepancy tolerance level, such discrepancy is flagged. Preferably, a notification is sent to a specified user such as human resources, management, or a legal department.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to. ” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U. S. C. §112, ¶6, other aspects may likewise be embodied as a means-plus-function claim, or in other forms, such as being embodied in a computer-readable medium. (Any claims intended to be treated under 35 U. S. C. §112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A computerized system for biometric-based tracking of individuals, the system comprising:
at least one processor, configured to execute the instructions of one or more software modules stored on a nonvolatile computer readable medium;
a media storage database;
a time entry database configured to store at least one time entry; and
an image processing module configured to transmit a digital image to a facial recognition service, wherein the image processing module is further configured to receive a response from the facial recognition service indicating an identity of a recognized person in the digital image, wherein the image processing module is further configured to store the digital image to the media storage database, wherein the image processing module is further configured to store a time entry to the time entry database, and
wherein the time entry comprises the identity and the time at which the digital image was taken.

2. The computerized system of claim 1, the system further comprising:
a dashboard module, wherein the dashboard module is configured to retrieve the digital image from the media storage database, wherein the dashboard module is further configured to retrieve the time entry from the time entry database, and wherein the dashboard module is further configured to provide a digital dashboard for presenting the digital image and the time entry to a user.

3. The computerized system of claim 2, wherein the dashboard module is further configured to receive a user request indicating a filtering criteria, and wherein the dashboard module is further configured to retrieve and present at least one at least one time entry based on the filtering criteria.

4. The computerized system of claim 3, wherein the dashboard module is further configured to retrieve timekeeper data from a timekeeping system based on the filtering criteria, wherein the dashboard module is further configured to analyze the timekeeper data to determine discrepancies between the timekeeper data and at least one time entry, and wherein the dashboard module is further configured to present the discrepancies between the timekeeper data and the at least one time entry.

5. The computerized system of claim 1, the system further comprising a local software application configured to receive the digital image from a camera and transmit the digital image to the image processing module.

6. The computerized system of claim 1, the system further comprising:
a local software application configured to receive the digital image from a camera and store the digital image and metadata about the digital image to a digital queue; and
wherein the image processing module is further configured to retrieve the digital image from the digital queue.

7. A computerized system for biometric-based tracking of individuals, the system comprising:
at least one processor, configured to execute the instructions of one or more software modules stored on a nonvolatile computer readable medium;
a local software application configured to receive a digital image from a camera and store the digital image and metadata about the digital image to at least one digital queue;
at least one image processing module configured to retrieve the digital image from the at least one digital queue, wherein the image processing module is further configured to transmit a digital image to a facial recognition service, wherein the image processing module is further configured to receive a response from the facial recognition service indicating an identity of a recognized person in the digital image, wherein the image processing module is further configured to store the digital image to a media storage database, wherein the image processing module is further configured to store a time entry to a time entry database, and wherein the time entry comprises the identity and the time at which the digital image was taken;
a dashboard module configured to retrieve the digital image from the media storage database, wherein the dashboard module is further configured to retrieve the time entry from the time entry database and to provide a digital dashboard for presenting the digital image and the time entry to a user, wherein the dashboard module is further configured to receive a user request indicating a filtering criteria, and to retrieve and present at least one digital image and at least one time entry based on the filtering criteria.

8. The computerized system of claim 7, wherein there are at least two image processing modules and at least two digital queues.

9. A computer-implemented method for biometric-based tracking of individuals, the computer-implemented method comprising the steps of:
transmitting a digital image to a facial recognition service;,
receiving a response from the facial recognition service indicating the identity of a recognized person in the digital image;
storing the digital image to a media storage database; and
storing a time entry to a time entry database, wherein the time entry comprises the identity and the time at which the digital image was taken.

10. The computer-implemented method of claim 9, the computer-implemented method further comprising the steps of:
retrieving the digital image from the media storage database;
retrieving the time entry corresponding to the digital image from the time entry database; and
providing a digital dashboard for presenting the digital image and the time entry to a user.

11. The computer-implemented method of claim 10, further comprising the step of receiving a user request indicating a filtering criteria, and
wherein at least one time entry is retrieved and presented based on the filtering criteria.

12. The computer-implemented method of claim 10, further comprising the steps of:
retrieving timekeeper data from a timekeeping system based on the filtering criteria;
analyzing the timekeeper data to determine discrepancies between the timekeeper data and at least one time entry; and
presenting the discrepancies between the timekeeper data and the at least one time entry.

13. The computer-implemented method of claim 9, the computer-implemented method further comprising the steps of:
receiving, by a local software application, the digital image from a camera; and
transmitting the digital image to the image processing module.

14. The computer-implemented method of claim 9, the computer-implemented method further comprising the steps of:
receiving, by a local software application, the digital image from a camera;
storing the digital image to a digital queue; and
retrieving the digital image from the digital queue.
